(19) United States
(12) Patent Application Publication
(10) Pub. No.: US 2019/0234614 A1
(43) Pub. Date: Aug. 1, 2019

(54) MODULAR TURBINE, IN PARTICULAR TURBINE WITH HEAT EXCHANGER FOR PRODUCING ENERGY, IN PARTICULAR ELECTRICAL ENERGY

(71) Applicant: IFP Energies nouvelles, Rueil-Malmaison (FR)

(72) Inventors: Hubert BAYA TODA, PARIS (FR); Jean-Baptiste MICHEL, RUEIL MALMAISON (FR); Julien THIRIOT, RUEIL MALMAISON (FR)

(73) Assignee: IFP Energies nouvelles, Rueil-Malmaison (FR)

(21) Appl. No.: 16/329,079

(22) PCT Filed: Jul. 11, 2017
(86) PCT No.: PCT/EP2017/067433

§ 371 Date: Feb. 27, 2019

(30) Foreign Application Priority Data
Aug. 29, 2016 (FR) 1657992

(51) Int. Cl. F23R 3/00; F02C 7/08

(52) U.S. Cl. CPC F23R 3/005; F02C 7/08

(57) ABSTRACT

The present invention is a turbine, particularly a turbine with heat exchanger for the production of energy, particularly electrical energy, comprising at least one compression stage (12) with at least one gas compressor (14), a cross-flow heat exchanger (16) comprising a compressed gas inlet header (60), a compressed gas outlet header (62), a superheated compressed gas inlet header (64), a cooled expanded gas outlet header (66), a combustion chamber (18), at least one expansion stage (20) with at least one expansion turbine (22) connected by a shaft (24) to the compressor, and a means (26) of producing energy.

According to the invention, the compressed gas outlet header (62) comprises the combustion chamber (18).

### CROSS REFERENCE TO RELATED APPLICATIONS

Reference is made to PCT/EP2017/067433 filed Jul. 11, 2017, and French Application No. 16/57.992 filed Aug. 29, 2016, which are incorporated herein by reference in their entirety.

### BACKGROUND OF THE INVENTION

### Field of the Invention

The present invention relates to a turbine, particularly to a turbine having a thermodynamic cycle with heat exchanger, for the production of energy, and in particular electrical energy and more particularly to a micro-turbine with recuperator for the production of electricity from a liquid or gaseous fuel. A micro-turbine is a turbine of low power usually below 200 kW.

### Description of the Prior Art

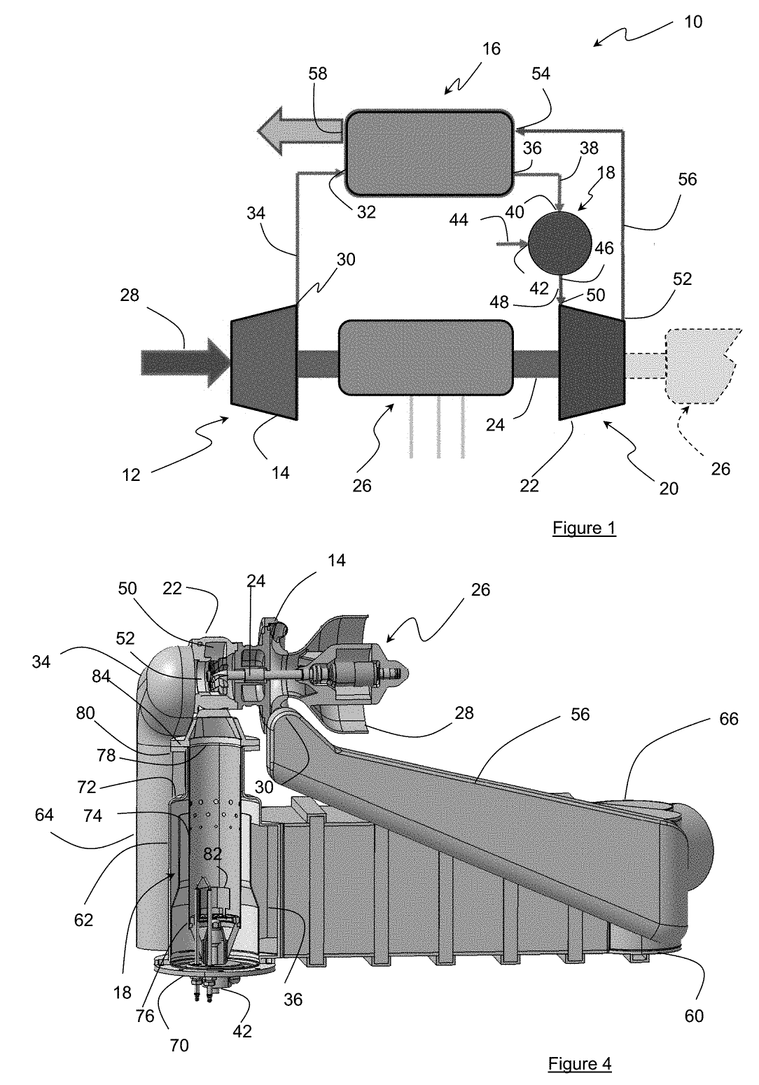

As is best shown by FIG. 1, which illustrates a turbine of the prior art, the turbine 10 comprises at least one compression stage 12 with at least one gas compressor 14, a heat exchanger 16 (or recuperator), a combustion chamber 18 (or burner), at least one expansion stage 20 with at least one expansion turbine 22 connected by a shaft 24 to the compressor. This turbine also comprises a means of producing energy, in this instance electrical energy, which comprises an electrical generator 26 advantageously placed on the shaft 24 between the compressor and the turbine.

Of course, and as has been illustrated in dotted line in FIG. 1, this generator may alternatively be connected to the expansion turbine by a shaft other than the one that connects the turbine and the compressor.

For preference, the heat exchanger 16 is a cross-flow exchanger, for example of the shell—tube type or of the alternating plates type, with two inlets and two outlets.

The compressor 14 comprises an inlet 28 for a fresh gas containing oxygen, in this instance external air generally at ambient temperature, and a compressed gas outlet 30 leading to a compressed gas inlet 32 of the exchanger 16 via a pipe 34. The hot compressed gas outlet 36 of this exchanger is connected by a line 38 to a hot compressed gas intake 40 of the combustion chamber 18. This combustion chamber also comprises a fuel inlet 42 connected by piping 44 to a reservoir (not depicted) to introduce a fuel into this combustion chamber. The superheated compressed gas outlet 46 of the combustion chamber is connected by a line 48 to the inlet 50 of the expansion turbine, the outlet 52 of which is connected to another inlet 54 of the exchanger by a superheated expanded gas pipe 56. The exchanger 16 also comprises an outlet 58 for cooled expanded gas which is to be directed towards any discharge and treatment means, such as a chimney (not depicted).

This design of turbine, although satisfactory, does have some significant disadvantages.

Specifically, the exchanger presents significant problems with size to guarantee satisfactory electrical efficiency because, depending on the technology employed in the exchanger, its volume may increase by a factor of 10.

In general, the technology most widely used for this type of exchanger is the cross-flow plate exchanger technology where very thin plates of the order of 0.3 to 0.2 mm thick are generally used so as to reduce the volume of such an exchanger.

Nevertheless, the volume of the exchanger remains high in comparison with the other components of the turbine. A problem of conforming to the tight constraints on integration in on-board applications then arises.

### SUMMARY OF THE INVENTION

The present invention makes it possible to overcome the aforementioned disadvantages thanks to a modular design of certain parts of the turbine and, more particularly, to the fact that the combustion chamber and the exchanger are grouped together into a single component making it possible to achieve a compact design.

This design thus makes it possible to greatly reduce the volume of the turbine and to achieve volume savings of the order of 30 to 40% by comparison with the prior art.

It also makes it possible to increase the performance of the cycle and reduce the overall cost by reducing pressure drops, notably between the exchanger and the combustion chamber, and the number of components.

To this end, the present invention relates to a turbine, particularly a turbine with heat exchanger for the production of energy, particularly electrical energy, comprising at least one compression stage with at least one gas compressor, a cross-flow heat exchanger comprising a compressed gas inlet header, a compressed gas outlet header, a superheated compressed gas inlet header, a cooled expanded gas outlet header, a combustion chamber, at least one expansion stage with at least one expansion turbine connected by a shaft to the compressor, and a means of producing energy, characterized in that the compressed gas outlet header comprises the combustion chamber.

The wall of the compressed gas outlet header may form the casing of the combustion chamber.

The compressed gas outlet header may be closed at one of its ends by a partition bearing the injector of the combustion chamber.

The outlet header may bear a base for attachment to the expansion turbine.

The other features and advantages of the invention will now become apparent from reading the following description, given solely by way of nonlimiting illustration, and to which are attached, in addition to

FIG. 1 which illustrates the prior art:

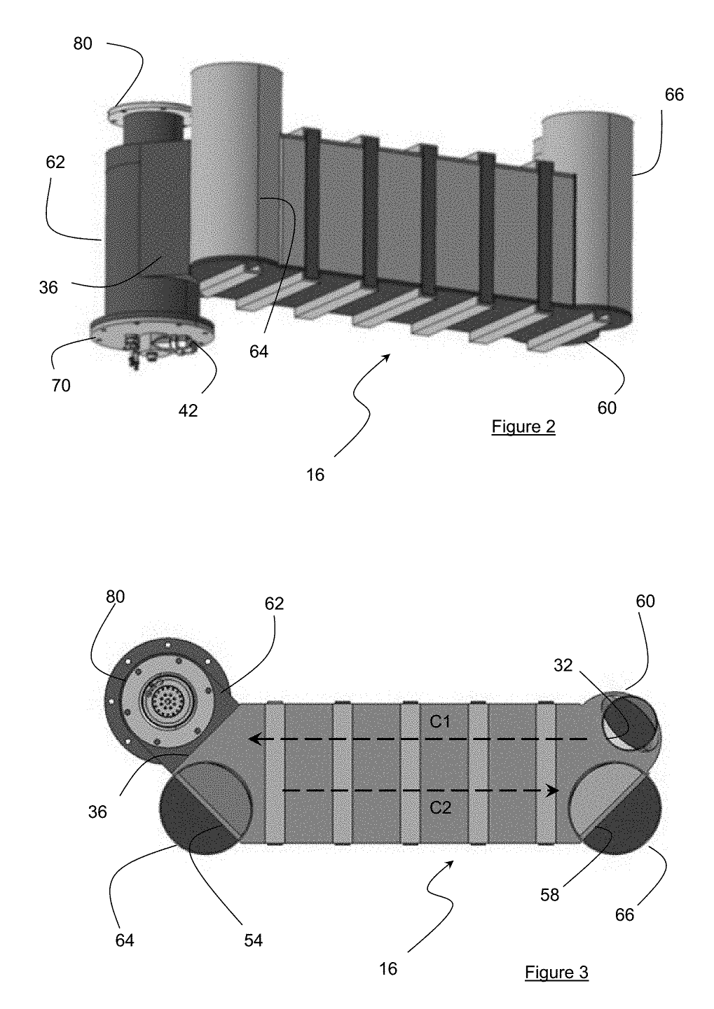

FIG. 2 which is a partial perspective view showing a modular embodiment of part of the turbine according to the invention,

FIG. 3 which schematically illustrates a view of FIG. 2 from above, and

FIG. 4 which shows the entirety of the turbine according to the invention.

### DETAILED DESCRIPTION OF THE INVENTION

FIGS. 2 and 3 are an illustration of a first step in a modular embodiment of part of the turbine which involves incorporating the combustion chamber 18 into the exchanger 20.

This exchanger is a cross-flow plate exchanger which comprises a stack of two sets of plates positioned to alternate with one another. This makes it possible to form a first flow stream of a first fluid in the first set of plates and a second flow stream of a second fluid in the other set of plates.

For that, the exchanger comprises a header 60 with the compressed gas inlet 32, referred to as the inlet header, placed at one of the ends of the exchanger, and another header 62 with the hot compressed gas outlet 36, referred to as the outlet header, placed at the other end of this exchanger, and both of which are in communication with the canals formed in the one same set of plates.

A first fluid can therefore circulate between the headers in the direction of the arrow C1.

This exchanger also comprises a header 64 with the superheated expanded gas inlet 54, referred to as the inlet header, placed at the opposite end of the exchanger to the end at which the inlet header 60 is situated, and another header 66 with the cooled expanded gas outlet 58, referred to as the outlet header, positioned at the opposite end of this exchanger to the end at which the outlet header 62 is situated. These two headers are in communication with the canals formed in the one same set of plates to allow a second fluid to circulate between these headers in the direction of the arrow C2 which is the opposite of the direction C1.

In the example of the invention, the first fluid is compressed gas coming from the compressor 14, whereas the second fluid is a superheated expanded gas coming from the expansion turbine 22.

With reference to FIG. 4 also, the combustion chamber is placed inside the outlet header 62 with the particular feature that the casing of this chamber is formed by the wall of this header.

As is better described in French application FR 15/59314 by the same applicant, the combustion chamber, in which the cylindrical outer casing is in this instance formed by the header 62 of the exchanger, is closed at one of the ends of the header 62 by a partition 70 bearing an injector for injecting at least one liquid and/or gaseous fuel 42. The other of the ends of this header comprises an annular partition 72 with an opening for the passage of a flame tube 74, likewise of substantially cylindrical shape, housed coaxially in the header and having a smaller diameter than this header. This tube has an end closed by a diffusion partition 76 facing and some distance away from the injector-bearing partition 70, and an open end 78, forming the outlet of the combustion chamber, which passes through the annular partition engaging sealingly with the inside diameter of this annular partition. Avantageously, the header 62 comprises, at the outlet 78 of the flame tube, a fixing base 80. Furthermore, this flame tube comprises a flame stabilizer 82 which is placed on the diffusion partition 76 and inside the tube.

Thus, the compressed gas coming from the exchanger through the gas outlet 36 enters the space formed between the wall of the header 62 and the flame tube and enters the space formed between the injector-bearing partition and the diffusion partition, to form a carburetted mixture capable of burning.

Of course, and without departing from the scope of the invention, any other type of combustion chamber can be used, such as the one described in greater detail in document WO 2012/039611.

In order to create a simple and compact module comprising the combustion chamber and the heat exchanger, the outlet header 62 is used as combustion chamber casing and houses all the other constituent elements (injector-bearing partition 70, flame tube 74, flame stabilizer 82, . . . ) of this chamber.

That also makes it possible to increase the performance of the turbine by reducing the surfaces that might generate heat losses while at the same time limiting the pressure drops between the exchanger and the combustion chamber.

In addition, this modular embodiment allows a reduction in heat losses between the outlet of the exchanger and the inlet of the combustion chamber and allows a reduction in the number of components and therefore a reduction in the cost of the assembly.

Another modular embodiment allows the turbocompressor assembly to be incorporated into the module formed by the combustion chamber and the exchanger.

In order to do that, and referring back to FIG. 4, the turbocompressor comprises a compressor 14 with a fresh gas intake 28 and a compressed gas outlet 30, an expansion turbine 22 connected to the compressor by a shaft 24 and comprising a superheated compressed gas inlet 50 and a superheated expanded gas outlet 52. The shaft 24 is extended beyond the compressor so as to be connected to a generator 26.

As illustrated in this FIG. 4, the outlet 30 of the compressor is connected to the inlet header 60 of the exchanger by a pipe 56 and the outlet 52 of the expansion turbine is connected to the inlet header 64 by a pipe 34.

Furthermore, the turbocompressor casing comprises, near the inlet 50 of the turbine 22, an attachment base 84.

In order to create a modular assembly comprising the exchanger/combustion chamber module and the turbocompressor, the latter is added and then attached by any means, such as by screws, to the exchanger/combustion chamber module by joining the fixing base 80 to the attachment base 84.

The pipe 34 and the pipe 56 are then fixed, likewise by any known means, between the outlet 52 of the turbine 22 and the header 64 and between the outlet 30 of the compressor and the inlet header 60 of the exchanger.

That allows ease of maintenance with a design made up of two easily separable modules which limits the amount of dismantling work required for intervention or maintenance.

In addition, this configuration makes it possible to limit pressure drops and heat losses between the outlet of the combustion chamber and the inlet of the turbine.

1.-4. (canceled)

5. A turbine including a heat exchanger for the production of energy, comprising:
at least one compression stage with at least one gas compressor;
a cross-flow heat exchanger comprising a compressed gas inlet header, a compressed gas outlet header, a superheated compressed gas inlet header and a cooled expanded gas outlet header;
a combustion chamber;
at least one expansion stage including at least one expansion turbine connected by a shaft to the at least one compressor;
a means of producing energy and wherein
the compressed gas outlet header comprises the combustion chamber.

6. The turbine according to claim 5, wherein a wall of the compressed gas outlet header forms the casing of the combustion chamber.

7. The turbine according to claim 5, wherein the compressed gas outlet header is closed at one end by a partition supporting an injector of the combustion chamber.

8. The turbine according to claim 7, wherein the compressed gas outlet header is closed at one end by a partition supporting the injector of the combustion chamber.

9. The turbine according to claim 5, wherein the outlet header supports a base for attachment to an expansion turbine.

10. The turbine according to claim 6, wherein the outlet header supports a base for attachment to an expansion turbine.

11. The turbine according to claim 7, wherein the outlet header supports a base for attachment to an expansion turbine.

12. The turbine according to claim 8, wherein the outlet header supports a base for attachment to an expansion turbine.

13. The turbine according to claim 5 comprising a generator of electrical energy.

14. The turbine according to claim 6 comprising a generator of electrical energy.

15. The turbine according to claim 7 comprising a generator of electrical energy.

16. The turbine according to claim 8 comprising a generator of electrical energy.

17. The turbine according to claim 9 comprising a generator of electrical energy.

18. The turbine according to claim 10 comprising a generator of electrical energy.

19. The turbine according to claim 11 comprising a generator of electrical energy.

20. The turbine according to claim 12 comprising a generator of electrical energy.
